(19) United States
(12) Patent Application Publication
(10) Pub. No.: US 2026/0294034 A1
(43) Pub. Date: Oct. 1, 2026

(54) Sporting article produced by means of an additive manufacturing process and method of manufacturing such an article

(71) Applicant: DECATHLON, VILLENEUVE-D'ASCQ (FR)

(72) Inventor: Rémi AMORETTI, VILLENEUVE-D'ASCQ (FR)

(73) Assignee: DECATHLON, VILLENEUVE-D'ASCQ (FR)

(21) Appl. No.: 19/343,461

(22) Filed: Sep. 29, 2025

Related U.S. Application Data
(63) Continuation of application No. PCT/FR2024/050419, filed on Mar. 29, 2024.

(30) Foreign Application Priority Data
Mar. 29, 2023 (FR) 23/03054

(51) Int. Cl. A43B 13/14; A43B 5/00; B33Y 80/00

(52) U.S. Cl. CPC A43B 13/14; A43B 5/00; B33Y 80/00

(57) ABSTRACT

A sports article including an element made via an additive manufacturing process. The element includes an external structure, an internal structure forming a three-dimensional lattice structure formed by repeating at least one elementary pattern; and an intermediate structure. The intermediate structure joins the external structure to the internal structure.

### CROSS-REFERENCE TO RELATED APPLICATIONS

This application is a continuation of International Application No. PCT/FR2024/050419, filed on Mar. 29, 2024, which claims priority to and the benefit of French Application 23/03054 filed on Mar. 29, 2023. The disclosures of the above applications are incorporated herein by reference.

### FIELD

The present disclosure relates to a sporting article produced by means of an additive manufacturing process and method of manufacturing such an article.

### BACKGROUND

The statements in this section merely provide background information related to the present disclosure and may not constitute prior art.

The additive manufacturing methods, such as the 3D printing, offer numerous advantages, including the ability to produce objects with varied and complex shapes, and in particular shapes that are difficult or impossible to produce using conventional methods. When using an additive manufacturing method, one wishes to create an object with specific mechanical behavior, and in particular mechanical behavior with a high level of elasticity, it is known to create at least part of such an object in the form of a three-dimensional mesh structure or lattice structure. In such a structure, the combination of solid zones and empty zones, combined with the use of a material with appropriate properties, makes it possible to obtain varied mechanical behaviors, without compromising the overall mass. A lattice structure with consistent mechanical properties is generally created by repeating a basic pattern, this pattern repeating itself along the longitudinal and transverse dimensions, and the thickness of the object. However, the constraints leading to the design of a lattice structure may result in the visual appearance of its external surface being unattractive, or in any case, not allowing sufficient freedom in the design of this external surface, which could impair the mechanical properties of the lattice structure.

### SUMMARY

This section provides a general summary of the disclosure and is not a comprehensive disclosure of its full scope or all of its features.

The aim of the present disclosure is to provide an element produced by means of an additive manufacturing method, the element including a lattice structure providing given mechanical properties, and an external surface whose visual appearance is independent of the lattice structure.

The present disclosure relates to a sports article including at least one part made by means of an additive manufacturing method. This application also concerns an article of footwear, such as a sports shoe, including such a sole. A sports article is, for example, a shoe sole (outer sole, including a midsole and/or an outsole), a body protection (knee pads, elbow pads, back protectors, etc.), a helmet, a saddle, or a child seat adaptable to a bicycle. To this end, the present disclosure concerns a sports article including an element made by means of an additive manufacturing method, the element including: an external structure; an internal structure, forming a three-dimensional mesh structure formed by the repetition of at least one elementary pattern; an intermediate structure, the intermediate structure providing the connection between the external structure and the internal structure.

Thus, by providing an external structure forming the external surface of the element, the external structure being connected to the internal structure by an intermediate structure, it is possible to make the design of the external structure and the design of the internal structure entirely independent. It thus becomes possible to maintain the mechanical and functional integrity of the internal structure, while defining the external structure according to the desired criteria, and in particular according to the desired visual appearance.

According to other features of the present disclosure, the sports article in accordance with the present disclosure comprises one or more of the following optional features, considered alone or in all possible combinations:

In one example, the intermediate structure includes connecting beams, each connecting beam connecting a node of an elementary pattern to the external structure.

In one example, the external structure is formed at least in part by a three-dimensional mesh structure including beams connected by nodes, each connecting beam of the intermediate structure being connected either to a node of the external structure or to a solid portion of the external structure.

In one example, for each connecting beam connected to a node of the external structure, the connecting beam is connected to this node based on a distance criterion between the node of the internal structure and the node of the external structure.

In one example, the distance criterion is satisfied if the distance between the node of the internal structure and the node of the external structure is greater than a threshold value.

In one example, the threshold value is strictly greater than the thickness of the connecting structure.

In one example, a connecting beam connected to a node of the internal structure is connected to the nearest node of the external structure.

In one example, a connecting beam connected to a node of the internal structure is connected to a node located at a distance included in a predetermined distance range, so as to meet at least one additional criterion, such as an angle between the connecting beam and the external structure at the connection.

In one example, the thickness of the connecting structure is less than or equal to 40% of the smallest dimension of a parallelepiped, in particular a rectangular parallelepiped, in which the elementary pattern of the internal structure is inscribed, and in one example less than or equal to 25% of this dimension.

The present disclosure also concerns a method for manufacturing a sports article as defined above, the method including: determining an external structure of the element; determining the internal structure inscribed within the internal volume delimited by the external structure, the internal structure being reduced relative to this internal volume so as to comply with at least one criterion relating to the truncation of at least one portion of the elementary patterns constituting the internal structure; determining an intermediate structure providing the junction between the internal structure and the external structure; producing the element by means of an additive manufacturing method.

In one example, the determining the intermediate structure includes determining nodes of elementary patterns to be connected to the intermediate structure.

In one example, the intermediate structure includes connecting beams, each connecting beam connecting a node of an elementary pattern to the external structure.

In one example, the external structure is formed at least in part by a three-dimensional mesh structure including beams connected by nodes, each connecting beam of the intermediate structure being connected either to a node of the external structure or to a solid portion of the external structure.

In one example, for each connecting beam connected to a node of the external structure, the connecting beam is connected to this node based on a distance criterion between the node of the internal structure and the node of the external structure.

In one example, the distance criterion is satisfied if the distance between the node of the internal structure and the node of the external structure is greater than a threshold value.

In one example, the threshold value is strictly greater than the thickness of the connecting structure.

In one example, a connecting beam is connected to the closest node.

In one example, a connecting beam is connected to a node located at a distance within a predetermined distance range, so as to satisfy at least one additional criterion, such as an angle between the connecting beam and the external structure at the connection.

In one example, the criterion relating to the truncation of the elementary patterns is a criterion defining a maximum degree of truncation of the elementary patterns.

In one example, the criterion is set such that no elementary pattern is truncated, or such that the maximum degree of truncation is less than or equal to 30%.

In one example, the thickness of the connecting structure is less than or equal to 40% of the smallest dimension of a parallelepiped, in particular a rectangular parallelepiped, in which the elementary pattern of the internal structure is inscribed, and in one example less than or equal to 25% of this dimension.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an element produced via an additive manufacturing method in accordance with one example of the present disclosure;

FIG. 2 is a cross-sectional view of the element of FIG. 1;

FIG. 3 is a perspective view of the element of FIG. 2;

FIG. 4 is a detailed view of FIG. 1;

FIG. 5 is a schematic perspective view of an elementary vintile-type pattern according to one example of the present disclosure;

FIG. 6 is a schematic view showing the internal structure of FIG. 2 with a non-homogeneous repetition of the elementary pattern;

FIG. 7 is a perspective view of a midsole of a sports shoe produced in accordance with the present disclosure;

FIG. 8 is a sectional view of the sole of FIG. 7;

FIG. 9 is a view similar to FIG. 4, the connecting structure not being defined by any connection distance criterion value according to one example of the present disclosure;

FIG. 10 is a view similar to FIG. 9, the connecting structure being defined by a first connection distance criterion value according to one example of the present disclosure;

FIG. 11 is a view similar to FIG. 9, the connecting structure being defined by a second connection distance criterion value according to one example of the present disclosure;

FIG. 12 is a diagram showing a manufacturing method in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

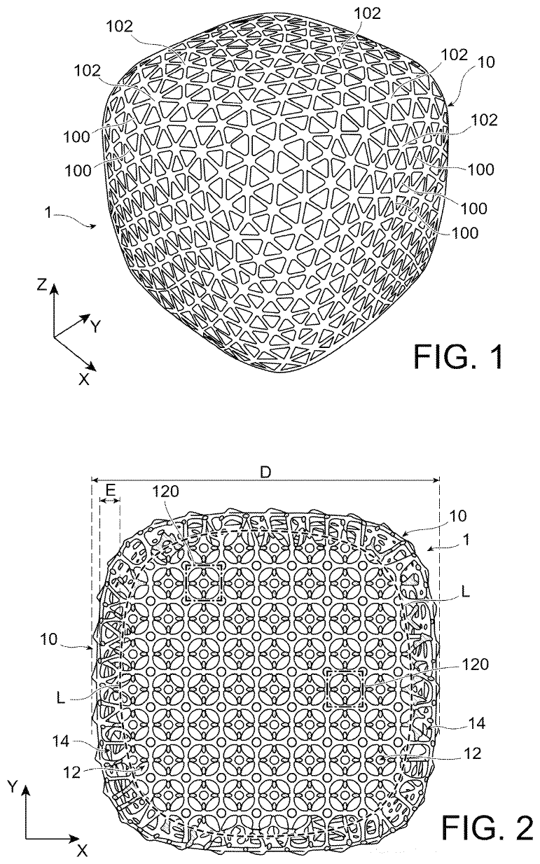

FIGS. 1 to 4 illustrate an element 1 in accordance with the present disclosure, in this example a block produced by means of a manufacturing method in accordance with the present disclosure, and intended to constitute a sports article or to form part of a sports article. The sports article may be, for example, a shoe sole (outer sole, including a midsole and/or an outsole), body protection (knee pad, elbow pad, back protector, etc.), a helmet, a saddle, a child seat adaptable to a bicycle, etc.

In this example, the element 1 is a block of generally cubic shape, which may, for example, serve as a constituent element of body protection such as a knee pad suitable for practicing a sport such as volleyball. FIG. 1 shows the element 1 in perspective. In this figure, only the external surface of the element 1 is visible, consisting or comprising of an external structure 10, or external skin 10.

FIGS. 2 to 4 show the element 1 of FIG. 1 seen in cross-section.

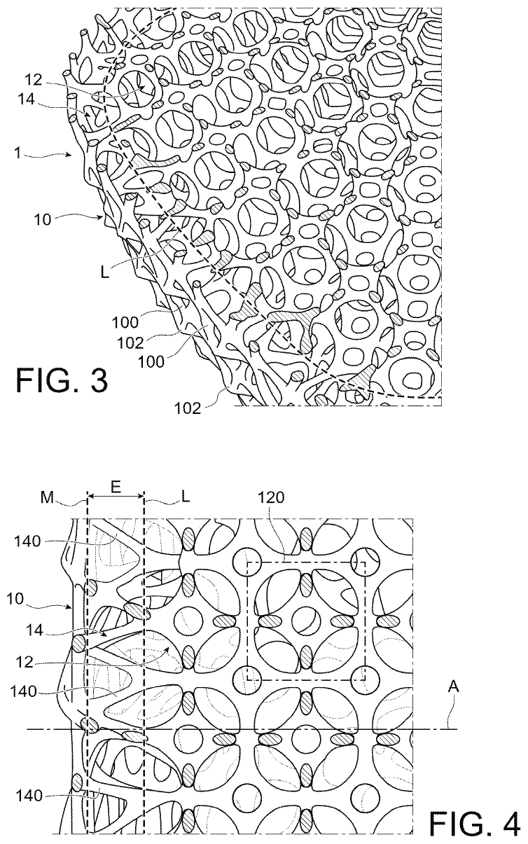

FIG. 2 is a perspective view of the element 1 in cross-section, that is to say, in a plane parallel to the plane XY of FIG. 1. FIG. 3 is a partial view similar to FIG. 2, with the element 1 seen in perspective. FIG. 4 is a detailed view of FIG. 2. As seen in FIGS. 2 to 4, the element 1 comprises three interconnected structures: an external structure 10, or external skin 10; an internal structure 12, or functional structure 12; an intermediate structure 14, or connecting structure 14, providing the junction between the external structure 10 and the functional structure 12.

The three structures 10, 12, and 14 are obtained jointly by means of an additive manufacturing method. The boundary between the intermediate structure 14 and the internal structure 12 is shown in FIGS. 2 to 4 by the dotted line L. The boundary between the external structure 10 and the intermediate structure 14 is shown in FIG. 4 by the dotted line M.

The internal structure 12 is formed by a three-dimensional mesh structure, that is to say, a lattice-type structure. Thus, the internal structure 12 is formed by the repetition, along each of the longitudinal X, transverse Y, and thickness Z directions of the element 1, of elementary patterns 120 that are described in more detail below. The structure of the elementary patterns 120, and the way in which they are repeated along the three directions X, Y, Z of the element 1, confer physical and mechanical properties to the internal structure 12, such as, for example, strength and elasticity properties, and, in particular, damping and energy restitution properties in the event of deformation.

The external skin 10, or external structure, forms the external surface of the element 1. In the example, the external structure 10 is formed by a three-dimensional mesh structure, formed partly by the repetition of elementary patterns, but not exclusively. The external structure 10 is the only structure of the element 1 that is entirely visible and is notably intended to give the element 1 the desired visual appearance. Of course, when the external structure 10 is formed at least in part by a three-dimensional mesh structure based on the repetition of an elementary pattern, the external structure 10 remains different from the internal structure 12.

The intermediate structure 14, or connecting structure, provides the junction between the external structure 10 and the internal structure 12. The intermediate structure 14 is, in this example, a three-dimensional mesh structure, including connecting beams 140. Providing an intermediate structure 14 provides a junction between the internal structure 12 and the external structure 10, this junction respecting, on the one hand, the mechanical behavior specific to the internal structure 12, and, on the other hand, the desired visual appearance of the external structure 10. Providing such an intermediate structure 14 makes it possible, in particular, to avoid alteration, or at least excessive alteration, of the elementary patterns 120 that would be located at the interface between the internal structure 12 and the external structure 10 in the absence of an intermediate structure. Indeed, the absence of a connecting structure could result in truncating a significant portion of many elementary patterns, and thus alter the overall mechanical behavior of the internal structure 12. The intermediate structure 14 also makes it possible to avoid excessively large aggregates of material that could adversely affect the mechanical behavior of the internal structure 12. In one example, the intermediate structure 14 will be as thin as possible. The thickness of the intermediate structure 14, which will depend in particular on the dimensions of the element 1 and also on the size of the elementary patterns of the internal structure 12, will in one example be less than 10 mm, or less than 6 mm.

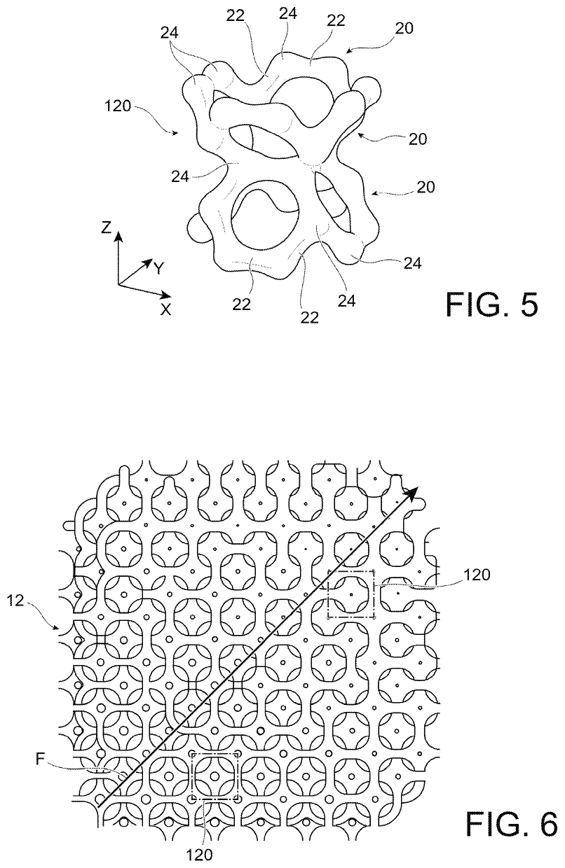

In the example, at least one portion of the internal structure 12 is formed by the repetition of an elementary vintile-type pattern 120, this elementary pattern being shown in perspective in FIG. 5. The use of this elementary pattern makes it possible to give the internal structure 12 the desired properties of elasticity, deformability, damping, and durability to give the element 1 the desired mechanical behavior. The internal structure 12 may, however, be formed by a lattice structure including other elementary patterns or comprising several types of elementary patterns. In particular, the internal structure 12 may include zones formed by the repetition of different patterns, with the aim of giving the element 1 damping, energy return, and strength properties that vary depending on the zone in question, or depending on other criteria. In a non-limiting manner, the following elementary patterns may be used: diamond pattern, octagonal edge pattern, octagonal vertex pattern, tetrahedral pattern, etc.

The mechanical features of the lattice structure of the internal structure 12 may be adapted, in particular by modifying the parameters of the elementary pattern, including the following parameters: size of the elementary pattern and number of repetitions on the considered axis (axes x, y, z visible in FIG. 1); the beam diameter, which is set primarily according to the desired stiffness for each beam: for example, it is comprised between 0.5 and 5 mm, or between 1 and 3 mm; the size of the nodes, a node being defined as the intersection of at least two beams: the size of a node is, for example, comprised between 100% and 130% of the diameter of the beams joining the node, or between 105% and 125%, or even between 110% and 120%; the radius of curvature at the intersection between two or more beams: for example, it is comprised between 1 and 5 mm, or between 2 and 3 mm. In one example, the radius of curvature is such that it is equal to the beam diameter multiplied by a factor between 1 and 2, for example, 1.5.

A vintile-type elementary pattern 120 is visible in FIG. 5. It is a three-dimensional elementary structure including a plurality of hexagonal-shaped elementary structures 20, each elementary structure 20 including six beams 22, some of these beams being common to at least two elementary structures. Nodes 24 connect two or more beams 22.

Like any elementary pattern, the vintile-type elementary pattern can be modified by varying several parameters, such as the size and number of repetitions along each axis x, y, and z, the diameter of the beam 22, the size of the nodes 24, or the radius of curvature at the intersection. The geometry of this elementary pattern, based on hexagonal shapes, notably gives a lattice structure a high impact absorption capacity and good energy restitution. The vintile-type elementary pattern can therefore be particularly suitable for producing sports shoe soles or absorbent elements for personal protection such as knee pads.

In the example, the size of the elementary pattern 120 is 11 mm×11 mm×11 mm, which means that the elementary pattern 120 is repeated within the internal structure 12 every 11 mm in each direction x, y, and z. In other words, the elementary pattern is inscribed in a rectangular parallelepiped whose dimensions are 11 mm×11 mm×11 mm.

In one example, as shown in FIGS. 2 and 4, the thickness E of the connecting structure 14 is less than or equal to 10%, and in one example 8%, of the total dimension D of the sports article measured in the same direction (direction A in FIG. 4). For a sports shoe sole, the thickness of the connecting structure 14 is, for example, less than or equal to 5 mm. Cumulatively or alternatively, the thickness E of the connecting structure 14 is less than or equal to 50% of the smallest dimension of a rectangular parallelepiped in which the elementary pattern of the internal structure 12 is inscribed. For example, for an elementary pattern 120 whose dimensions are those given above, the thickness E is less than or equal to 5.5 mm. In one example, the thickness E is less than or equal to 40%, or even 25%, of the smallest dimension of the rectangular parallelepiped in which the elementary pattern of the internal structure 12 is inscribed.

FIG. 6 shows an example of the internal structure 12 of the element 1 in which the beam diameter of the elementary patterns 120 increases progressively along the arrow F. For the same type of elementary pattern, increasing the beam diameter will increase the strength of the internal structure 12, but will, in turn, decrease its elasticity.

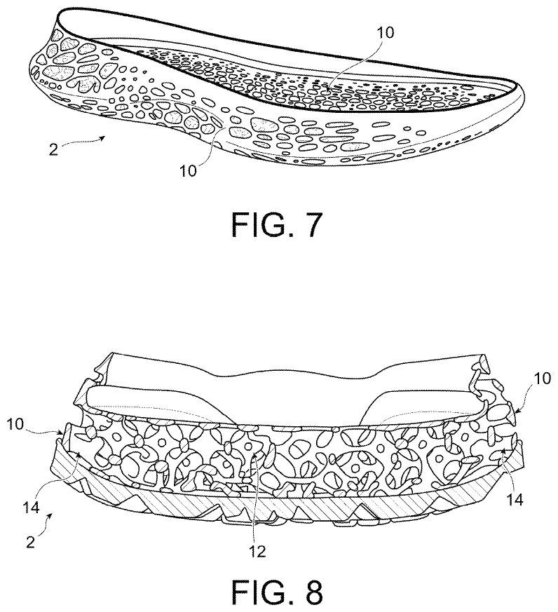

FIGS. 7 and 8 show a midsole 2 of a sports shoe according to the present disclosure. The sole 2 includes an external structure 10 forming, in particular, the covering of the sole, and an internal structure 12, visible in FIG. 8, which represents the sole 2 seen in section. As with element 1 of FIGS. 1 to 4, the sole 2 includes an intermediate structure 14 providing the junction between the internal structure 12 and the external structure 10.

A method in accordance with the present disclosure is described below, in particular with reference to FIG. 12, allowing to obtain sports articles including elements such as those described above.

Such a method includes an operation 200 during which an external structure 10 of the element 1 is determined. This structure is determined based on the external volume of the element to be produced and the desired type of structure: the external structure may be solid or form a three-dimensional mesh structure, or may include both solid and mesh portions.

The method then includes an operation 202 during which the internal structure 12 inscribed in the internal volume delimited by the external structure is determined, the internal structure being reduced relative to this internal volume so as to comply with at least one criterion representative of the integrity of at least one portion of the elementary patterns constituting the internal structure. This criterion may, for example, be a degree of truncation (average or maximum) permitted for all the elementary patterns of the internal structure. For example, this criterion may be used to impose that no elementary pattern be truncated. Alternatively, it may be used to impose that no elementary pattern be truncated beyond a given degree of truncation. The degree of truncation may, for example, be expressed as a percentage giving the truncated volume relative to the initial volume of the elementary pattern. This value will be, for example, 30%, meaning that each elementary pattern will retain a volume after truncation greater than or equal to 70% of its initial volume.

The method includes an operation 204 during which an intermediate structure 14 is determined, providing the junction between the internal structure and the external structure. This operation makes it possible to determine the set of connecting beams 140 that will connect an elementary pattern of the internal structure to the external structure. In one example, each connecting beam 140 will be connected to a node of an elementary pattern 120. The method will thus comprise a sub-operation aimed at determining the set of nodes of elementary patterns to be connected to the connecting structure. The concerned elementary patterns are the elementary patterns forming the external surface of the internal structure 12. Among these elementary patterns, it is determined which nodes must be attached to the external structure, and therefore connected to the intermediate structure. To distinguish these nodes, the following rule can be applied, for example: any node that intersects fewer than three beams of the elementary pattern must be connected to the intermediate structure and therefore to a connecting beam 140. Thus, each node that must be connected to the external structure 10 will be connected to a connecting beam 140.

Each connecting beam 140 will further be connected to the external structure 10. If, near a connecting beam 140, the external structure 10 includes a mesh portion, therefore including beams 100 connected by nodes 102, the connecting beam 140 will be connected to a node 102. Thus, each connecting beam 140 will be connected either to a node or to a solid portion of the external structure 10.

The definition of each connecting beam may follow one or more criteria. Among these criteria, a first distance criterion will be applied, that is to say, the choice of the connection location between a connecting beam 140 and the external skin 10 will be a function of the distance to the connection location between this connecting beam 140 and the internal structure. For example, this distance may as short as possible. Or it may be the shortest possible distance by taking into account one or more additional criteria, such as the angle between the connecting beam and the external structure at the connection. The size criteria (diameter, length, etc.) and the shape criteria (for example, the connecting beam may have a particular shape, such as a helical shape) may also be taken into account.

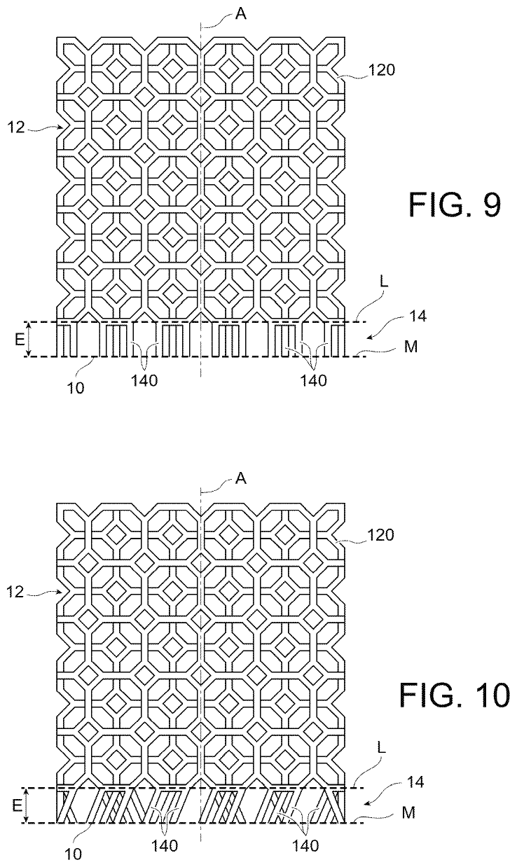

FIGS. 9 to 11 are views similar to FIG. 4 showing the influence of the distance criterion mentioned above, or connection distance criterion.

The value of the thickness E of the connecting structure 14 being fixed, the distance criterion will influence the length of the connecting beams 140, and, consequently, the angle formed by these connecting beams 140 and the direction normal to the direction tangent to the external structure 10 at the location of the connection of a given connecting beam 140 (in the example of FIGS. 9 to 11, the external structure 10 being rectilinear, the normal direction is constant and corresponds to the direction of the axis A). In the example of FIGS. 9 to 11, the value of the thickness E is fixed at approximately 5 mm.

In the example of FIG. 9, no distance criterion has been imposed, and it can be seen that each connecting beam 140 is connected to the nearest node of the internal structure 12. This configuration implies, as visible in FIG. 9, that each connecting beam 140 extends in the direction normal to the tangent to the external structure 10, and therefore, in the example, in a direction parallel to the axis A.

In the example of FIG. 10, a distance criterion is imposed, and, more precisely, a distance strictly greater than a threshold value equal to 10 mm is imposed. This implies that each connecting beam 140 must be connected to a node of the internal structure 12 located more than 10 mm from its point of connection with the external structure 10. In other words, each connecting beam must have a length strictly greater than 10 mm. This constraint implies that the connecting beams can no longer be connected to the nearest node of the internal structure 12. As can be seen, this constraint influences the angle formed between each connecting beam and the direction normal to the tangent to the external structure 10, which is then non-zero. Thus, each connecting beam 140 is inclined with respect to the direction normal to the tangent to the external structure 10, and therefore with respect to the axis A.

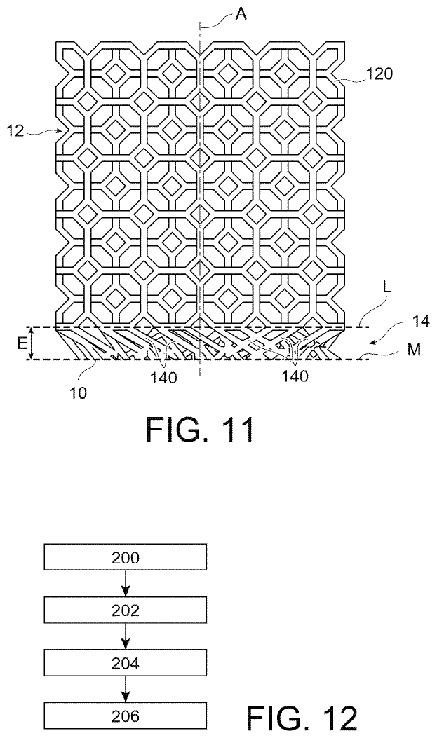

In the example of FIG. 11, a distance criterion similar to that of FIG. 10 is imposed, but the threshold value is here equal to 15 mm. This results in an angle between each connecting beam 140 and the direction normal to the tangent to the external structure 10 greater than that induced in the case of FIG. 10. In other words, the connecting beams 140 are more strongly inclined relative to the axis A in the case of FIG. 11. Imposing a distance criterion as illustrated in FIGS. 10 and 11 makes it possible to improve the mechanical behavior of the connecting structure 14, in particular when flexibility and cushioning qualities are desired, for example in the case of a shoe sole.

At the end of this operation, the intermediate structure is determined so as to act as a junction between the internal and external structures, so as to best respect the functional integrity of the internal structure and thus improve the mechanical behavior of the entire obtained element 1.

The method then includes the operation 206 of producing the element 1, including the three structures determined as described above, by means of an additive manufacturing method. The element 1 may form the sports article itself, or form only a portion thereof, in which case a step of assembling the element 1, for example to a support or another element of the sports article, may be desired.

Additional operations may be implemented after the additive manufacturing. For example, a sandblasting operation makes it possible to clean and smooth the surface of the resulting element, which may be useful for improving the aesthetics of the element and its performance. A chemical smoothing operation can also be implemented after additive manufacturing. This operation improves the durability of the component, as well as its aesthetic appearance.

The method can be implemented with any type of suitable material, in particular thermoplastic materials, such as polymeric materials such as polyurethane, polyethylene, polypropylene, polystyrene, polycarbonate, acrylonitrile butadiene styrene, polyamide, polyethylene terephthalate, thermoplastic copolyamide, ether-amide block copolymer, etc.

The method in accordance with the present disclosure is suitable for the production of sports articles that may include elements produced by additive manufacturing, such as, for example: shoe soles (outer soles, including a midsole and/or an outsole), body protection (knee pads, elbow pads, back protectors, etc.), helmets, bicycle saddles, a child seat adaptable to a bicycle, etc.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1-21. (canceled)

22. A sports article, comprising:
an element produced by additive manufacturing, the element including:
an external structure;
an internal structure having a three-dimensional mesh structure formed by a repetition of at least one elementary pattern; and
an intermediate structure providing a junction between the external structure and the internal structure.

23. The sports article according to claim 22, wherein the intermediate structure includes a plurality of connecting beams, each connecting beam connecting a node of an elementary pattern to the external structure.

24. The sports article according to claim 23, wherein the external structure is formed by a second three-dimensional mesh structure including a plurality of beams connected by a plurality of nodes, each connecting beam of the intermediate structure connected to a node of the plurality of nodes of the external structure or to a solid portion of the external structure.

25. The sports article according to claim 24, wherein, for each connecting beam connected to the node of the plurality of nodes of the external structure, each connecting beam is connected to the node according to a criterion of distance between the node of the elementary pattern and the node of the plurality of nodes of the external structure.

26. The sports article according to claim 25, wherein the criterion is satisfied based on a distance between the node of the internal structure and the node of the plurality of nodes of the external structure being greater than a threshold value.

27. The sports article according to claim 26, wherein the threshold value is greater than a thickness of a connecting structure.

28. The sports article according to claim 27, wherein a thickness of the connecting structure is less than or equal to 40% of a smallest dimension of a rectangular parallelepiped in which the elementary pattern of the internal structure is inscribed.

29. The sports article according to claim 25, wherein each connecting beam connected to the node of the elementary pattern is connected to a nearest node of the plurality of nodes of the external structure.

30. The sports article according to claim 25, wherein each connecting beam connected to the node of the elementary pattern is connected to the node of the plurality of nodes of the external structure located at a distance included in a predetermined distance range to comply with at least one additional criterion, and the at least one additional criterion is an angle between each connecting beam and the external structure at a connection location.

31. A method for manufacturing a sports article including an element provided to be produced via an additive manufacturing method according to claim 22, the method comprising:
determining an external structure of the element;
determining the internal structure inscribed in an internal volume delimited by the external structure, the internal structure configured to be reduced in relation to this internal volume so as to comply with at least one criterion relating to a truncation of at least a portion of elementary patterns constituting the internal structure;
determining an intermediate structure providing the junction between the internal structure and the external structure; and
producing the element via additive manufacturing.

32. The method according to claim 31, wherein the determining the intermediate structure includes determining nodes of elementary patterns to be connected to the intermediate structure.

33. The method according to claim 32, wherein the intermediate structure includes connecting beams, each connecting beam connecting a node of an elementary pattern to the external structure.

34. The method according to claim 33, further comprising forming the external structure by a three-dimensional mesh structure including a plurality of beams connected by a plurality of nodes, each connecting beam of the intermediate structure being connected either to a node of the plurality of nodes of the external structure or to a solid portion of the external structure.

35. The method according to claim 34, wherein, for each connecting beam connected to the node of the plurality of nodes of the external structure, the method further comprises connecting each connecting beam to the node of the plurality of nodes according to a distance criterion between the node of the internal structure and the node of the plurality of nodes of the external structure.

36. The method according to claim 35, wherein the distance criterion is satisfied based on a distance between the node of the internal structure and the node of the plurality of nodes of the external structure being greater than a threshold value.

37. The method according to claim 36, wherein the threshold value is greater than a thickness of a connecting structure.

38. The method according to claim 34, further comprising connecting each connecting beam to a nearest node.

39. The method according to claim 34, further comprising connecting each connecting beam to a node of the plurality of nodes located at a distance included in a predetermined distance range to satisfy at least one additional criterion, wherein the at least one additional criterion is an angle between each connecting beam and the external structure at a connection location.

40. The method according to claim 39, wherein the at least one criterion relating to the truncation of the elementary patterns is a criterion defining a maximum degree of truncation of the elementary patterns.

41. The method according to claim 40, wherein the criterion is set so that no elementary pattern is truncated, or so that the maximum degree of truncation is less than or equal to 30%.

42. The method according to claim 31, wherein a thickness of a connecting structure is less than or equal to 40% of a smallest dimension of a rectangular parallelepiped in which the elementary patterns of the internal structure is inscribed.
